(19) United States
(12) Patent Application Publication
(10) Pub. No.: US 2007/0195801 A1
(43) Pub. Date: Aug. 23, 2007

(54) Context-based processing of data flows

(75) Inventors: Vesa Hellgren, Helsinki (FI); Julius Karlsson, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/471,615

(22) Filed: Jun. 21, 2006

(30) Foreign Application Priority Data
Feb. 23, 2006 (EP) 06003727.2

(51) Int. Cl. H04L 12/56

(52) U.S. Cl. 370/401

(57) ABSTRACT

The present invention relates to a network node, method and computer program product for processing a data flow based on a context information, wherein a dynamic data structure (DIF) associated with an active data flow is created, when a data packet belonging to said active data flow is received. At least a portion of a determined secondary context information of the received data packet is stored in said dynamic data structure and subsequent data packets of the active data flow are processed based on the content of the dynamic data structure. Accordingly, secondary PDP context can be supported when differential processing is applied.

### FIELD OF THE INVENTION

The present invention relates to a method, network node and computer program product for processing a data flow based on a context information. In particular, the present invention relates to a differentiated processing, such as a charging processing, for secondary Packet Data Protocol (PDP) contexts.

### BACKGROUND OF THE INVENTION

Advanced content has grown due to new powerful handsets for mobile communication systems. This has increased the need for systems by means of which network operators can provide their customers with access to third party services without loosing the control over the usage. The need is both for delivering content to end-users and for charging for it.

Typically, a service can be located in the Internet or another packet data network using a combination of protocol, address and port information. The Uniform Resource Identifier (URI) is common, although not the only way to combine this information. It is a compact string of characters for identifying an abstract or physical source. A human-readable textual representation of an IP address is accomplished by using the Domain Name System (DNS).

The Internet provides different services such as browsing, e-mail, messaging and streaming. Apart from plane information retrieval, browsing can be used among other purposes for various kinds of business transactions, gaming or for locating and launching other services. E-mail transfer is based on a store-and-forward method, where the message may wait on intermediate servers until it reaches its destination. Streaming service can be defined as a simultaneous transmission and usage of data, in which the use begins before all the data is transmitted to the user. In practice, this means for example sending real-time flows of audio and video over the Internet. The real-time nature of streaming sets special requirements for underlying network in structure and protocols. On one hand, the intermediate network elements should be able to guarantee adequate quality of service (QoS), so that enough data can be transferred per time unit. On the other hand, the application, content, and protocol should adapt to changing network conditions, like available bandwidth and delay. Lots of research has been done on QoS, but support for it in the heterogeneous network environment of the Internet is still pure. On the protocol side, Real Time Protocol (RTP), Real Time Control Protocol (RTCP), and Real Time Streaming Protocol (RTSP) are the most important developments for carrying actual content and related control information, and for controlling the streaming. Second-generation mobile networks has been designed for voice calls. The problem with this approach is inflexible resource allocation and poor user-experience. No matter what amount of data is to be transferred, there is a fix capacity reserved and available, and the user is charged according to the duration of a session. A solution to this problem was to add packet data services to the existing networks. In the Global System for Mobile communication (GSM) this was achieved with the General Packet Radio Services (GPRS) standard, which maintained the existing radio interface, but provided enhanced features for packet data services.

The GPRS upgrade introduced new functional elements to the GSM network. A packet control unit (PCU) in the base station system takes care of packet segmentation, radio channel access, automatic retransmission and power control. A Serving GPRS Support Node (SGSN) keeps track of the individual mobile stations location and performs security functions and access control. It is located at the same hierarchical level as the mobile switching center (MSC) of the GSM network, and the base station system connects to it with a frame relay connection. Furthermore, a Gateway GPRS Support Node (GGSN) provides interworking with external packet data networks, such as the Internet. It is connected with SGSNs via an IP-based GPRS backbone network. When a mobile station wishes to communicate with packet data, it needs to request a PDP context activation from the core network. The SGSN creates a connection to a GGSN the user has identified with an access point name (APN). A GPRS tunneling protocol (GTP) is used to carry the data of a single context between the SGSN and the GGSN. The GGSN converts the tunneled data to normal IP traffic and forwards the data to the destination configured for that APN. The destination may be, for example, a Wireless Application Protocol (WAP) gateway, an operator's Internet gateway (border gateway), a third party Internet service provider, or a corporate intranet. Te provide enhanced functionalities required for content delivery, such as service charging and user interaction, an Intelligent Content Delivery (ICD) solution has been developed, which is used to make the GPRS system service aware. ICD allows the definition of services. Each service is defined basically as set of flows specifications, where each flow specification consists of e.g. IP address or subnet, and port number.

A network elements involved in the ICD solution is the GGSN, because it is the gateway between the GPRS system and public or private data networks. In other words, all traffic between the GPRS system and public or private data networks can be analyzed in the GGSN. In the ICD system, the GGSN becomes service aware, which means that it supports both service switching and differentiated charging. Both of these new technologies are based on flow specifications which are used to classify traffic. Each flow specification includes also parameters which control the charging, so that the GGSN is able to charge each traffic flow differently based on the matching flow specification. Service switching makes it possible to access different public or private data networks under the same PDP context.

Furthermore, the GPRS networks support streaming. For example, viewing of a streaming video or audio imposes constraints for e.g. delay between the packets. These real-time applications require that the packets are received in a continuous flow. The basic Internet offers just best effort QoS, which has no realtime guarantees. In the GPRS networks, QoS requirements have been taken into account. The device (or user equipment (UE) in 3^{rd} generation terminology) may request specific QoS for the PDP context. As the QoS requirements of the applications can be highly different, it is necessary that the GPRS networks support also different QoS profiles for different concurrent applications. To this end, the third generation partnership project (3 GPP) standardization has defined secondary PDP contexts which make it possible to have multiple PDP contexts with different QoS profiles.

As stated above, one of the core features of the ICD system and GGSN is the support for differentiated charging, i.e., IP flows can be charged differently based on the used protocol, destination address, etc. The radio network is one of the key resources in the GPRS system, and the use of radio resources should be taken into account in the charging function. Usage of radio resources depends on the QoS profile of the PDP context. Thus, for many operators the support for differentiated charging related to the secondary PDP contexts is essential, because then the operator can use the selected QoS profile as one of the input parameters when the price of the service is determined. For example, viewing a video clip may cost 0.20 £ when best-effort QoS is used, while the exactly same video clip could cost 1 £ with real-time QoS profile.

According to the current 3GPP standardization, this problem is solved by having the UE send uplink packets in any arbitrary secondary PDP context. For the downlink packets, the GGSN defines the secondary PDP context of the packet based on a traffic flow template (TFT) GGSN receives from the UE. The UE may change the TFT any time. Thus, the packets belonging to a certain service may be passed over various secondary PDP contexts. However, charging or other types of processing are based on events (e.g. viewing of one video clip is one event), so that a problem arises how to associate any QoS profile with this event which actually consists of multiple IP packets which may have been using various secondary PDP contexts.

In summary, the problem is to support differentiated processing (e.g. differentiated charging) together with multiple secondary PDP contexts. When the packets of some service are processed (usage of the service is charged), the used QoS profile should be known.

A prior art solution in the GGSN release 4.0 specification was not to allow secondary PDP contexts when the differentiated charging was applied, because the GGSN was not able to associate the secondary PDP context and the related QoS profile with distinct services.

Another related QoS solution based on Treatment Classes (TREC) has been developed. According to this solution, the QoS profile used in the PDP context is monitored and respectively upgraded or downgraded based on the static configuration in the GGSN. For example, if the PDP context is requesting streaming QoS, the use of the streaming QoS is allowed only when there is real streaming traffic pre-configured in streaming servers. This solution is however not related to the basic problem, because it does not provide any means to handle differentiated processing. Instead, this solution just controls what QoS is actually allowed for the PDP contexts.

### SUMMARY OF THE INVENTION

It is therefore an object of the present invention to provide support for context-based differentiated processing.

This object is achieved by a method of processing a data flow based on a context information, said method comprising the steps of:
creating a dynamic data structure associated with an active data flow to which a received data packet belongs;
determining a secondary context information of said received data packet;
storing at least a portion of said secondary context information of said received data packet in said dynamic data structure; and
processing subsequent data packets of said active data flow based on the content of said dynamic data structure.

Furthermore, the above object is achieved by a network node for processing a data flow based on a context information, said network node comprising:
creating means for creating a dynamic data structure associated with an active data flow to which a received data packet belongs;
determination means for determining a secondary context information of the received data packet;
storing means for storing said dynamic data structure which comprises at least a portion of said secondary context information of said received data packet; and
processing means for applying a processing in relation to subsequent data packets of said active data flow based on the content of said dynamic data structure.

Additionally, the above object is achieved by a computer program product comprising code means for generating the above method steps when run on a computer device.

Accordingly, the dynamic data structure provides a link between an active data flow and a secondary context information, so that secondary PDP contexts can be supported when differentiated processing, such as charging, is applied. Operators can thus use QoS as one of the parameters for content-based processing, e.g. the price of a service. The network node (e.g. GGSN) is able to monitor consistent use of PDP contexts, and can thus apply differentiated policies or other processing based on the monitoring result. For those cases where the dynamic data structure has already been created, e.g. based on an uplink packet, the TFT can be ignored. The configuration may even state that the dynamic data structure is never activated unless the first packet comes from the UE, so that the TFT is actually never needed and implementation of user equipments and concerned network nodes can be simplified.

The processing step may be used for generating a differentiated charging information. A static data structure may be provided which defines at least one static processing parameter and data flows to which the static processing parameter is to be applied. As an example, the static data structure may be arranged as a tuple comprising an uplink address information or subnet information, a protocol identifier, a port number, and the static processing parameter. In particular, the tuple may comprise at least one wild card information. Thereby, the static data structure may relate to a large number of different data flows comprising parameters of the static data structure as common parameters. If the processing relates to the example of charging processing, the processing parameter may comprise a static charging information which defines how the data flows are to be charged. The static charging information may comprise a metering information and an identifier information for reporting charging data.

Furthermore, the dynamic data structure may comprise at least one dynamic processing parameter of the active data flow. It may be arranged as a tuple comprising an uplink address information or subnet information, a protocol identifier, a port number, and the dynamic processing parameter. The dynamic data structure may be created dynamically when the active data flow belongs to data flows defined by the static data structure. If the differentiated processing relates to the example of charging processing, the dynamic processing parameter may comprise a dynamic charging information which defines how the active data flow is to be charged. The dynamic charging information may comprise a reference to a charging configuration of the static data structure, a counter for metered charging data associated with the active data flow, and a reference to the secondary context information.

The determining step may differ for uplink and downlink packets. In particular, the secondary context information may be determined for a downlink packet based on a traffic flow template and for an uplink packet based on a used transmission tunnel. This traffic flow template may however be ignored if a dynamic data structure related to the active data flow has already been created.

The processing step may comprise a policing step based on the content of the dynamic data structure. This policing step may comprise the steps of determining, from the dynamic data structure, the secondary context information, comparing the secondary context information with the secondary context information of a subsequent data packet, and applying a policy based on the result of the comparing step. If this result indicates different secondary contexts, at least one of the following steps may be performed:
dropping the subsequent packet;
terminating the secondary context related to the secondary context information; and
recording a violation in a statistic and passing the subsequent packet normally.

Additionally, the created dynamic data structure may be deleted when the secondary context related to the secondary context information is determined to be terminated.

It is considered apparent to the skilled person that the steps of the above proposed method and all subordinated modification steps can be implemented by a software program which controls a network node in which the above problem is implemented. This computer program product may be recorded on a computer-readable medium or may be configured as a software program which can be downloaded from the Internet.

### BRIEF DESCRIPTION OF THE DRAWINGS

The present invention will be now be described in greater detail based on a preferred embodiment with reference to the accompanying drawings, in which:

FIG. 1 shows a schematic network architecture of a content delivery system, in which the present invention can be implemented;

FIG. 2 shows a simplified messaging diagram of a differentiated processing according to the preferred embodiment;

FIG. 3 shows a schematic block diagram of a network node according to the preferred embodiment;

FIG. 4 shows a schematic flow diagram of differentiated charging function according to the preferred embodiment; and

FIG. 5 shows a schematic flow diagram of a differentiated policy function according to the preferred embodiment.

### DESCRIPTION OF THE PREFERRED EMBODIMENT

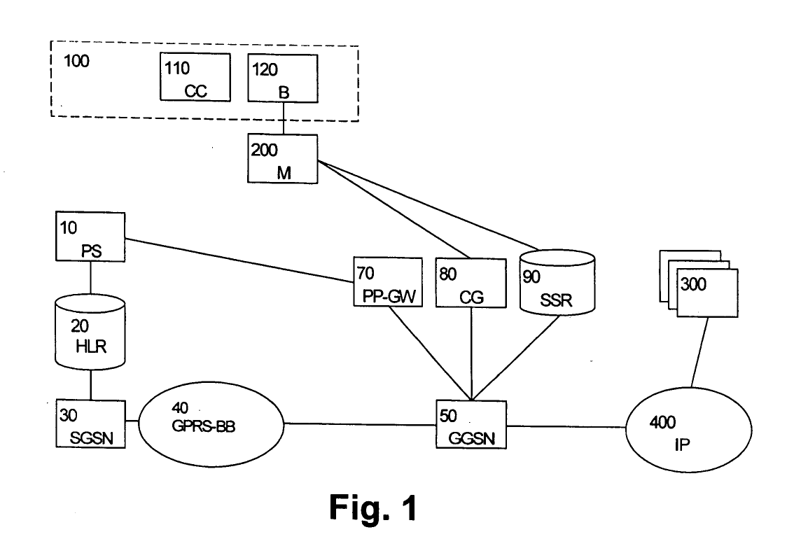

In the following, the preferred embodiment of the present invention will be described with respect to an intelligent content delivery (ICD) architecture for a GPRS system as shown in FIG. 1.

The idea of the ICD architecture is to analyze traffic flowing from the end user's terminal to the Internet. According to the preferred embodiment, the architecture comprises a traffic analyzing element or unit which implements this functionality in a GPRS support node, e.g., a GGSN 50. Additionally, a prepaid gateway 70, a charging gateway 80 and a service and subscriber repository element 90 are provided to fully implement the functionality. The purpose of the traffic analyzing unit is to enable access to third party content services 300 containing digital content and applications for end users. Typically, no difference may be made between internal and external applications. Standard network elements make the framework that the rest of the architecture has been built on. Shortly described, the elements are SGSN 30 and GPRS backbone 40 as core network elements described above. In a mobile environment, it is advantageous to use a TCP/IP (Transmit Control Protocol/Internet Protocol) protocol stack optimized for wireless traffic.

A prepaid system 10 and a home location register (HLR) 20 are part of the core network CN, where the HLR 20 stores subscriber data, and the prepaid system 10 takes care of users' prepaid accounts. Money can be reserved and then committed or roll-backed, e.g., during a voice call. In GSM, the prepaid function is based on Intelligent Networks.

A mediation function 200 processes and delivers charging information between the core network elements and the business support system. It may as well mediate the information coming from the network edge.

Furthermore, a billing function 120 and a customer care function 110 are part of an operator's business support system 100, which takes care of the monetary transactions between the operator, post-paid subscribers and value-added service providers. It is also used to add network and value-added services to the subscribers.

The service and subscriber repository element 90 contains all information about the subscribers (i.e., the users) and the services available for them. As. this information largely controls the functionality of the traffic analyzing element 200, the operator's existing user base may be migrated into it.

Because pre- and post-paid users must be able to use the services, appropriate interfaces are needed to both types of billing infrastructure. For post-paid users, charging data records (CDRs) are created as an established way to deal with charging. The charging gateway 80 implements the charging gateway function defined by the 3 GPP specification TS32.200 V5.10, June 2002. For example, the SGSN 30 and GGSN 50 may use it to transfer the charging records to the billing function 120. The charging gateway 80 has a logic to combine CDRs from several sources. In the prepaid case, cooperation is needed with the IN-based core network prepaid system, which has traditionally taken care of the charging during circuit switched calls. Also other applications are expected to use the IN prepaid interfaces directly. The architecture provides the prepaid gateway 70. It acts as a mediator or proxy towards the prepaid system. It allocates monetary quota for a user's traffic and content from the IN system, and reports the used portion in real-time. Network elements that want to support a real prepaid usage model query the prepaid gateway 70 before the user is allowed to finish any transactions.

The traffic analyzing unit provided in the GGSN 50 analyzes all IP traffic received from the GPRS backbone 40 (i.e., traffic originated from mobile terminals), recognizes traffic going to content services, and takes an action according to rules specified in a service and subscriber repository element 90.

Furthermore, the GGSN 50 provides access to the Internet domain ID with an IP-based network 400, e.g., the Internet. The GGSN 50 receives IP traffic inside GTP tunnels from the SGSN 30. When the IP traffic is passed to the traffic analyzing unit inside the GGSN 50, information about used secondary PDP context(s) is included. Thus, the GGSN 50 can detect or determine used secondary PDP context(s) for uplink packets. After the GGSN 50 there is no more GTP tunneling, so that the information about secondary PDP contexts is not available anymore.

According to the preferred embodiment, two objects, static IP flow (SIF) and dynamic IP flow (DIF) are provided as two new objects for context-based differentiated processing. SIF is part of the static configuration and defines one chargeable service component. The SIF can be defined as a tuple, as follows:
SIF=(UL_addr, proto, port, C),
where UL_addr defines an uplink address or subnet, proto is an IP protocol identifier (e.g. TCP), port is the port number used in UDP (datagram protocol) or TCP, and C defines how the SIF is charged. C can be defined as a tuple, as follows:
C=(id, m)
where id is an identifier used when charging data is reported, and m defines how the chargeable service component is metered (e.g. based on volume, hits and/or time). The DIF is similar to the SIF, but is created dynamically when IP traffic belonging to a certain SIF is detected. The DIF can be defined as a tuple, as follows:
DIF=(UL_addr, proto, port, URI, C′),
where UL_addr is the uplink address, proto is the IP protocol identifier (e.g. TCP), port is the port number used in UDP or TCP, and C′ defines how the DIF is charged.

Unlike in the SIF, the DIF may not use any wild cards or ranges when the attributes are defined. For example, the SIF may be defined as (123.34.5.6., *, *, C), which means that all traffic going to the IP address 123.34.5.6 match with the SIF, while the corresponding DIF shall always be like (123.34.5.6, TCP, 80, C′). In other words, there is always one DIF per each distinct “connection”, and there might be multiple active DIFs related to one SIF.

The charging data C′ related to the DIF can be defined as a tuple, as follows:
C′=(C, c, PDP)
where C is a reference to the charging configuration in the SIF, and c contains the counters for the metered charging data (e.g. how many bytes are to be charged). The last attribute PDP of the tuple C′ defines the secondary PDP context associated with the DIF. Thereby, all packets belonging to a certain DIF (i.e. “service”) can be associated with a certain QoS profile and the QoS can be accounted for differentiated processing, which may be a differentiated charging.

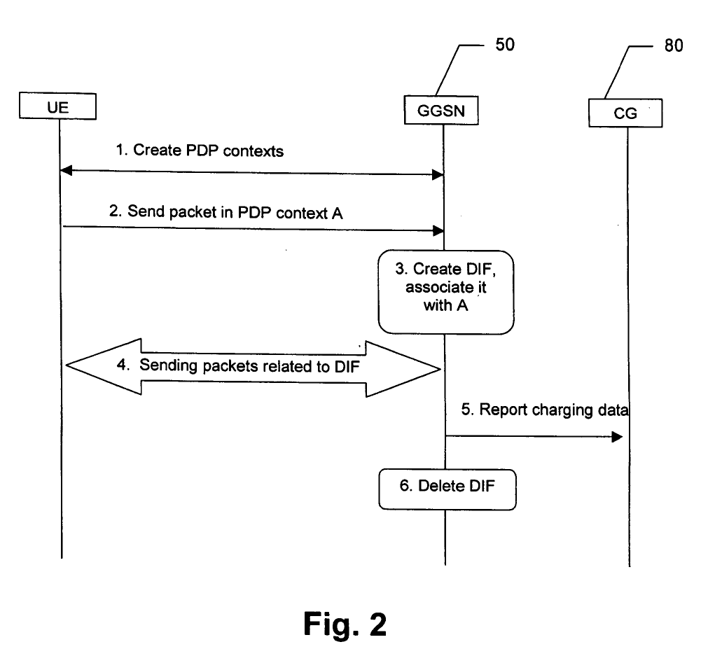

FIG. 2 shows a messaging diagram reflecting the general idea of the preferred embodiment by defining a use case and related message flows. Initially, in step 1, a mobile subscriber (with a UE) creates a session which has at least two secondary PDP contexts, while it is assumed that no DIFs are initially related to the mobile subscriber. A packet in PDP context A is sent in step 2 from the UE to the GGSN 50. As there is no active DIF related to the received packet, the GGSN 50 searches for a matching SIF related to the packet. Then, in step 3, the GGSN 50 creates a DIF related to the packet, i.e., associated with the PDP context A. To this end, the GGSN 50 determines the secondary PDP context of the packet, which is different for uplink and downlink packets. The secondary PDP context and the related QoS profile are then associated with the packet and recorded in the DIF. The counters c related to the packet are updated. Then, in step 4, packets related to the DIF are sent or transmitted between the UE and the GGSN 50. Each time a packet is received, which belongs to the same DIF, the counters c related to the DIF are updated. When the data flow or event is finished, differentiated charging data is reported in step 5 to the charging gateway 80. Finally, in step 6, the DIF can be deleted at the GGSN 50.

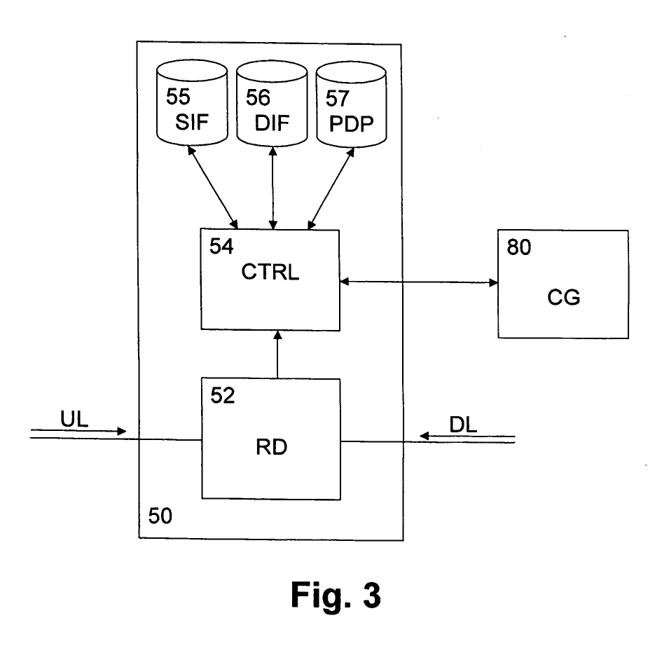

FIG. 3 shows a schematic block diagram of the GGSN 50 with the traffic analyzing functionalities relating to the preferred embodiment. A receiving and detection function or unit 52 receives uplink (UL) or downlink (DL) packets and provides address or subnet information, protocol information, port information or other traffic related information to a processing control function or unit 54. Additionally, TFT information may be detected at the receiving and detection function 52, based on which a secondary PDP context is determined. The PDP contexts and secondary PDP contexts are stored by the processing control unit 54 in a corresponding PDP storage 57. In addition, an SIF storage 55 is provided for storing predefined SIFs as static data structures for different sets of data flows. Furthermore, a DIF storage 56 is provided, in which DIFs created by the processing control function 54 are stored as dynamic data structures associated with active data flows. The storages 55 to 57 may be provided as separate storages or separate portions of a single storage or data base. In the preferred embodiment, the processing control function 54 is configured to generate charging information supplied to the charging gateway 80.

The functionalities of the receiving and detection unit 52 and the processing control unit 54 may be based on hardware implementations or, alternatively, on software routines controlling a central processing unit of the GGSN 50. They may be arranged as a single processing unit or function.

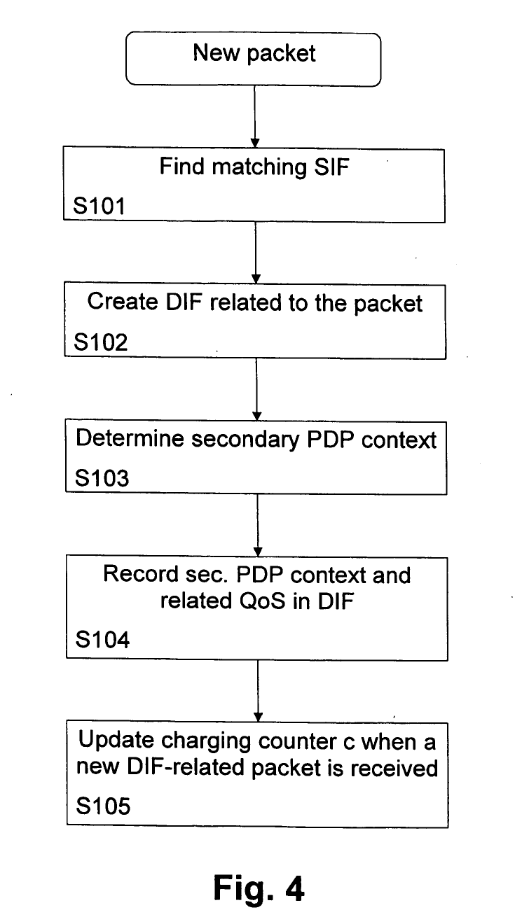

FIG. 4 shows a schematic flow diagram of a differentiated charging function of the processing control unit 54, for generating charging data. The processing routine of FIG. 4 is started each time a new packet is received. In step S101, the processing control unit 54 looks for a matching SIF in the SIF storage 55, based on the traffic information received from the receiving and detection unit 52 (S101). Then, in step S102, the processing control function 54 creates a DIF related to the packet. In this example, it is assumed that no DIF has been created for this active data flow. In step S103, the secondary PDP context of the received data packed is determined, e.g., by accessing the PDP storage 57 or detecting the TFT information of the packet. Thereafter, in step S104, the determined secondary PDP context and related QoS is added to or recorded in the created DIF which is stored in the DIF storage 56. Then, the charging counter c of the created DIF is updated each time a new packet related to the created DIF is received (S105).

Another, additional, alternative or optional processing may be a policing processing to be initiated when a packet is received. Here, the secondary PDP context of the packet is determined and the result is compared with the PDP value stored in the related DIF, a policing function is selected by the processing control unit 54.

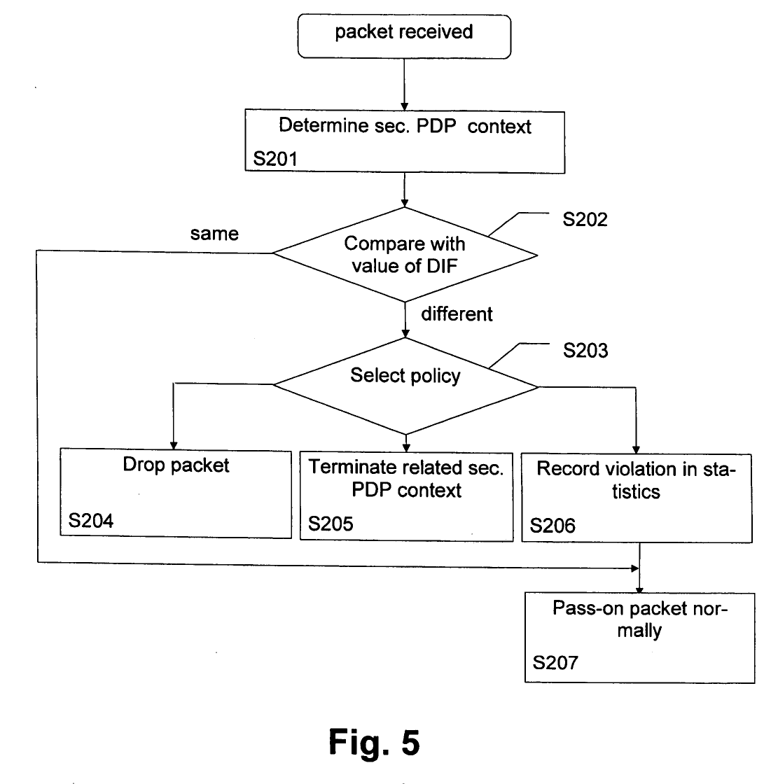

FIG. 5 shows a schematic flow diagram of such a policing processing according to the preferred embodiment. This processing may be initiated each time a downlink or uplink packet is received.

In step S201, the secondary PDP context of the received packet is determined. Then, a comparison of the determined secondary PDP context for the current packet with the PDP information of the related DIF is made in step S202. If both secondary PDP contexts are the same, the procedure branches to step S207 and the packet is passed-on normally without any policing function. If the secondary PDP context of the received packet differs from the secondary PDP context information of the related DIF, a specific policy is selected in step S203. In this regard, the GGSN 50 has several options which may be selected e.g., based on settings of the network operator. As a first option, the packet may be dropped (S204). All packets related to a certain IP flow should use the same secondary PDP context, so that a packet with a different secondary PDP context should be dropped or discarded. As a second option, the related secondary PDP context may be terminated (S205) based on an assumption that the active data flow has ended. As a third option, the detected violation may be recorded in statistics (S206), and then the packet may still be passed-on normally (S207). A network operator will then know that the differentiated charging is not strictly accurate. Based on the statistics, the network operator may begin to control the GGSN 50 with a different policy in future. For example, the network operator may initially use the third option to guarantee that end-user experience is never spoiled. Later, if the statistics reveal that there are very little violations, the network operator may change the policy to avoid potential revenue losses.

The difference between UL and DL packets is the way how the secondary PDP context is determined. For UL packets, the secondary PDP context is defined by the used GTP tunnel between the SGSN 30 and the GGSN 50. For DL packets, the secondary PDP context can be defined by the TFT. Furthermore, for DL traffic, the GGSN 50 may basically define the secondary PDP context of the packet by itself. Thereby, the TFT of the received data packet may be ignored, if there is already a related DIF, because then the secondary PDP context of the packet can be selected as the one listed in the related DIF.

The DIF is thus a dynamic data structure which is associated with some active IP traffic flow. The GGSN 50 may perform garbage collection and all unused DIFs stored in the DIF storage 56 may be cleared when there is no longer any active IP traffic relating to such unused DIFs. When a new packet is received, which is related to the deleted DIF, a new DIF can be created, which may now use a different secondary PDP context.

Finally, if the secondary PDP context is terminated, the related DIFs are also removed. Any subsequent packet related to a deleted DIF will then create a new DIF associated with some of the existing secondary PDP contexts.

Now, a specific example of the above preferred embodiment is described in more detail.

It is assumed that the static configuration of the GGSN 50 contains the following SIFs in the SIF storage 55:
A=(123.34.5.6, *, *, C1)
B=(123.54.6.7, *, *, C2)
wherein the symbol “*” denotes wild cards used as placeholders for the protocol identifier proto and the port number port. These parameters are thus not specified.

Furthermore, it is assumed that only the SIF A is allowed for mobile subscribers. The related charging information C1 is defined as C1=(1, volume) which means that “1” is used as identifier for reporting the charging data, and metering is performed based on the volume.

It is now assumed that the mobile subscriber creates two secondary PDP contexts X and Y. The secondary PDP context Y uses real-time QoS, while the secondary PDP context X uses best effort QoS. The mobile subscriber starts using services and an UL TCP packet addressed to IP address 123.34.5.6 and port 80 is received in the GGSN 50. The GGSN 50 notices that no DIFs are provided, which relate to the packet, but the SIF A matches with this packet. The GGSN 50 creates DIF A′, wherein A′=(123.34.5.6, TCP, 80, C1′). The dynamic charging information C1′ is then defined as C1′=(1, volume, 0, X). The packet was related to the secondary PDP context X and is thus recorded to C1′. The size of the packet is determined, and the volume-based counter c is updated in DIF A′.

Now, another packet is received from the DL direction. It matches with the DIF A′. The GGSN 50 has now two options:
It can send the packet in secondary PDP context X, because it is listed in the DIF A′.
It can use the TFT to determine the secondary PDP context. If the secondary PDP context defined by the TFT is actually Y, the GGSN 50 has the following options:
   a) The GGSN 50 drops the packet, because it is using a “wrong” PDP context. This may cause problems in the UE, but it guarantees that the differentiated charging is accurate.
   b) The GGSN 50 ignores the TFT and uses the PDP context X in any case.
   c) The GGSN 50 used the PDP context Y, but the violation event is recorded in the statistics.
   d) The PDP context Y is terminated, which forces the UE to use the correct PDP context X.

The volume counter c of the DIF A′ is updated in any case.

Still another packet is now received from the DL direction. It does not match with the DIF A′, but it matches with the SIF A. Consequently, a new DIF A″ is created, wherein A″=(123.34.5.6, UDP, 535, C1″) and C1″ is defined as C1″=(1, volume, 0, Y). The GGSN 50 now uses the TFT to determine the PDP context related to the packet, and it is Y. This value is recorded in C1″.

The UE may update the TFT at any time, but it really does not affect the implementation, because the TFT is actually needed only when there is no DIF related to a downlink packet. In other cases, the GGSN 50 can just ignore the TFT.

Additional packets are received in both UL and DL directions, which belong to either DIF A′ or DIF A″. The volume counter c is updated in a respective DIF and the GGSN 50 will monitor whether the PDP context is the one listed in the DIF. The GGSN 50 will then report the charging data to the external network elements, e.g. the charging gateway 80, which are now able to take into account the used QoS when the price of bytes is determined. Eventually, there is not traffic related to DIF A′ (and/or A″), so that the DIF A′ (and/or A″) can be deleted.

If the GGSN 50 receives a data packet related to SIF B, it will be dropped, because the mobile subscriber has not subscribed to the related service.

Thus, definition of different DIFs is possible to achieve differentiated charging or other differentiated processing based on the secondary PDP context, and it can be determined how the received data packets are mapped to different DIFs. Furthermore, different policies can be supported when the UE is arbitrarily sending packets in various secondary PDP contexts. Conventional GGSNs do not maintain enough information about active IP flows to support such policing. The used policy may be defined as part of the SIF configuration. Then, the used policy might be based on the related service. Additionally, a possibility is given to ignore the TFT of downlink data packets when a related DIF already exists.

In summary, a network node, method and computer program product have been described for processing a data flow based on a context information, wherein a dynamic data structure (DIF) associated with an active data flow is created, when a data packet belonging to said active data flow is received. At least a portion of a determined secondary context information of the received data packet is stored in said dynamic data structure and subsequent data packets of the active data flow are processed based on the content of the dynamic data structure. Thereby, secondary PDP contexts can be supported when differential processing is applied.

Although the above preferred embodiment has been described for the GGSN 50, the present invention could be used as well in the SGSN 30 or any other network node through which a concerned data flow is routed, wherein the receiving and detection unit 52 and the processing control unit 54 with the storages 55 to 57 would be provided at the SGSN 30 or the respective other network node.

It is also noted that the present invention is not restricted to the above preferred embodiment, but may be used in any kind of processing which can be differentiated based on the content or service of the related data flow. Moreover, the static and dynamic data structures may be arranged and stored in other data configurations with other parameters and sets of parameters. The static data structure may correspond to or may be derived from usual data provided at conventional GGSNs, SGSNs or corresponding other network nodes. The preferred embodiments my thus vary within the scope of the attached claims.

1. A method of processing a data flow based on a context information, said method comprising the steps of:
a) creating a dynamic data structure associated with an active data flow to which a received data packet belongs;
b) determining a secondary context information of said received data packet;
c) storing at least a portion of said secondary context information of said received data packet in said dynamic data structure; and
d) processing subsequent data packets of said active data flow based on the content of said dynamic data structure.

2. The method according to claim 1, wherein said processing step is used for generating a differentiated charging information.

3. The method according to claim 1, further comprising the step of providing a static data structure which defines at least one static processing parameter and data flows to which said static processing parameter is to be applied.

4. The method according to claim 3, further comprising the step of arranging said static data structure as a tuple comprising an uplink address information or subnet information, a protocol identifier, a port number, and said static processing parameter.

5. The method according to claim 4, wherein said tuple may comprise at least one wild card information.

6. The method according to claim 3, wherein said processing parameter comprises a static charging information which defines how said data flows are to be charged.

7. The method according to claim 6, wherein said static charging information comprises a metering information and an identifier information for reporting charging data.

8. The method according to claim 1, wherein said dynamic data structure comprises at least one dynamic processing parameter of said active data flow.

9. The method according to claim 8, further comprising the step of arranging said dynamic data structure as a tuple comprising an uplink address information or subnet information, a protocol identifier, a port number, and said dynamic processing parameter.

10. The method according to claim 3, further comprising the step of creating said dynamic data structure dynamically when said active data flow belongs to data flows defined by said static data structure.

11. The method according to claim 8, wherein said dynamic processing parameter comprises a dynamic charging information which defines how said active data flow is to be charged.

12. The method according to claim 11, wherein said dynamic charging information comprises a reference to a charging configuration of said static data structure , a counter for metered charging data associated with said active data flow, and a reference to said secondary context information.

13. The method according to claim 1, wherein said determining steps differs for uplink and downlink packets.

14. The method according to claim 13, further comprising the step of determining said secondary context information for a downlink packet based on a traffic flow template and for an uplink packet based on a used transmission tunnel.

15. The method according to claim 14, further comprising the step of ignoring said traffic flow template if a dynamic data structure related to said active data flow has already been created.

16. The method according to claim 1, wherein said processing step comprises a policing step based on the content of said dynamic data structure.

17. The method according to claim 16, wherein said policing step comprises the steps of determining from said dynamic data structure said secondary context information, comparing said secondary context information with the secondary context information of a subsequent data packet and applying a policy based on the result of said comparison step.

18. The method according to claim 17, wherein, if said result indicates different secondary contexts, at least one of the following steps is performed:
dropping said subsequent packet;
terminating the secondary context related to said secondary context information; and
recording a violation in a statistic and passing said subsequent packet normally.

19. A method according to claim 1, further comprising the step of deleting said created dynamic data structure when the secondary context related to said secondary context information is determined to be terminated.

20. A network node for processing a data flow based on a context information, said network node comprising:
a) creating means for creating a dynamic data structure associated with an active data flow to which a received data packet belongs;
b) determination means for determining a secondary context information of said received data packet;
c) storing means for storing said dynamic data structure which comprises at least a portion of said secondary context information of said received data packet; and
d) processing means for applying a processing in relation to subsequent data packets of said active data flow based on the content of said dynamic data structure.

21. The network node according to claim 20, wherein said processing means is configured to apply a differentiated charging processing.

22. The network node according to claim 20, wherein said processing means is configured to apply a policing processing to said received data packet and said subsequent data packets, based on a comparison of said secondary context information with a secondary context information of a related dynamic data structure.

23. The network node according to claim 20, wherein said processing means is configured to ignore a traffic flow template provided in said received data packet, if a related dynamic data structure is already stored in said storing means for said data packet.

24. The network node according to claim 20, wherein said network node is a support node for a General Packet Radio Services network.

25. A computer program product embodied on a computer readable medium, the computer program comprising code means for controlling a computer device to perform the steps of:
creating a dynamic data structure associated with an active data flow to which a received data packet belongs;
determining a secondary context information of said received data packet;
storing at least a portion of said secondary context information of said received data packet in said dynamic data structure; and
processing subsequent data packets of said active data flow based on the content of said dynamic data structure.

26. An apparatus for processing a data flow based on a context information, said apparatus comprising:
a) a creation unit for creating a dynamic data structure associated with an active data flow to which a received data packet belongs;
b) a determination unit for determining a secondary context information of said received data packet;
c) a storage unit for storing said dynamic data structure which comprises at least a portion of said secondary context information of said received data packet; and
d) a processing unit for applying a processing in relation to subsequent data packets of said active data flow based on the content of said dynamic data structure.
